(19) United States
(12) Patent Application Publication
(10) Pub. No.: US 2018/0115854 A1
(43) Pub. Date: Apr. 26, 2018

(54) SOUND-REPRODUCING METHOD AND SOUND-REPRODUCING SYSTEM

(71) Applicant: HTC Corporation, Taoyuan City (TW)

(72) Inventors: Jen-Ta HSU, TAOYUAN CITY (TW); Wan-Hsieh LIU, TAOYUAN CITY (TW)

(21) Appl. No.: 15/791,399

(22) Filed: Oct. 23, 2017

Related U.S. Application Data
(60) Provisional application No. 62/412,851, filed on Oct. 26, 2016.

(51) Int. Cl. H04S 7/00

(52) U.S. Cl. CPC H04S 7/303; H04S 2400/15

(57) ABSTRACT

A sound-reproducing method used in a virtual reality environment that includes the steps outlined below is provided. Positioning information is generated by receiving laser-positioning signals from a signal source by at least two sensors located at a head of a user. A head circumference of the user is calculated according to the positioning information by a processing module disposed in a head-mounted device. At least one spatial parameter of an audio data is adjusted according to the head circumference of the user by the processing module. A sound signal is reproduced according to the adjusted audio data by a sound-reproducing module disposed in the head-mounted device.

### RELATED APPLICATIONS

This application claims priority to U.S. Provisional Application Ser. No. 62/412,851 filed Oct. 26, 2016, which is herein incorporated by reference.

### BACKGROUND

### Field of Invention

The present disclosure relates to a sound-reproducing technology. More particularly, the present disclosure relates to a sound-reproducing method and a sound-reproducing system.

### Description of Related Art

Spatial and surround sound audio processing is becoming a more common feature of video and other audio playing devices. When a sound is generated from a sound-reproducing module, different users may have different perceptions of the spatial quality of the sound due to different physical characteristics of the users, e.g. the distance between two ears of each the users. As a result, when the sound-reproducing module is used in a head-mounted device, the spatial quality of the sound generated therefrom may not be suitable for every user.

Accordingly, what is needed is a sound-reproducing method and a sound-reproducing apparatus to address the issues mentioned above.

### SUMMARY

An aspect of the present disclosure is to provide a sound-reproducing method used in a virtual reality environment that includes the steps outlined below is provided. Positioning information corresponding to at least two sides of a head of a user is generated according to laser-positioning signals. A head circumference of the user is calculated according to the positioning information. At least one spatial parameter of an audio data is adjusted according to the head circumference of the user. A sound signal is reproduced according to the adjusted audio data.

Another aspect of the present disclosure is to provide a sound-reproducing system used in a virtual reality environment. The sound-reproducing system includes a sensor module, a processing module and a sound-reproducing module. The sensor module is configured to generate positioning information corresponding to at least two sides of a head of a user by receiving laser-positioning signals from a signal source. The processing module is disposed in a head-mounted device and is configured to calculate a head circumference of the user according to the positioning information and further adjust at least one spatial parameter of an audio data according to the head circumference of the user. The sound-reproducing module is disposed in the head-mounted device and is configured to reproduce a sound signal according to the adjusted audio data.

Yet another aspect of the present disclosure is to provide a non-transitory computer readable storage medium that stores a computer program including a plurality of computer readable instructions to perform a sound-reproducing method used in a sound-reproducing system that is used in a virtual reality environment. The sound-reproducing system at least includes a processing module configured to access a memory that stores the instructions and execute the instructions to perform the sound-reproducing method. The sound-reproducing method includes the steps outlined below. Positioning information corresponding to at least two sides of a head of a user is generated according to laser-positioning signals. A head circumference of the user is calculated according to the positioning information. At least one spatial parameter of an audio data is adjusted according to the head circumference of the user. A sound signal is reproduced according to the adjusted audio data.

These and other features, aspects, and advantages of the present invention will become better understood with reference to the following description and appended claims.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a block diagram of a sound-reproducing system used in a virtual reality environment in an embodiment of the present disclosure;

FIG. 2 is a block diagram of a sound-reproducing system used in a virtual reality environment in another embodiment of the present disclosure; and

FIG. 3 is a sound-reproducing method in an embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

It will be understood that, in the description herein and throughout the claims that follow, when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Moreover, “electrically connect” or “connect” can further refer to the interoperation or interaction between two or more elements.

It will be understood that, in the description herein and throughout the claims that follow, although the terms “first,” “second,” etc. may be used to describe various elements, these elements should not be limited by these terms. These terms are only used to distinguish one element from another. For example, a first element could be termed a second element, and, similarly, a second element could be termed a first element, without departing from the scope of the embodiments.

It will be understood that, in the description herein and throughout the claims that follow, the terms “comprise” or “comprising,” “include” or “including,” “have” or “having,” “contain” or “containing” and the like used herein are to be understood to be open-ended, i.e., to mean including but not limited to.

It will be understood that, in the description herein and throughout the claims that follow, the phrase “and/or” includes any and all combinations of one or more of the associated listed items.

It will be understood that, in the description herein and throughout the claims that follow, words indicating direction used in the description of the following embodiments, such as “above,” “below,” “left,” “right,” “front” and “back,” are directions as they relate to the accompanying drawings. Therefore, such words indicating direction are used for illustration and do not limit the present disclosure.

It will be understood that, in the description herein and throughout the claims that follow, unless otherwise defined, all terms (including technical and scientific terms) have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any element in a claim that does not explicitly state “means for” performing a specified function, or “step for” performing a specific function, is not to be interpreted as a “means” or “step” clause as specified in 35 U.S.C. § 112(f). In particular, the use of “step of” in the claims herein is not intended to invoke the provisions of 35 U.S.C. § 112(f).

Reference is made to FIG. 1. FIG. 1 is a block diagram of a sound-reproducing system 1 used in a virtual reality environment in an embodiment of the present disclosure.

The sound-reproducing system 1 includes a sensor module 100, a processing module 102, a sound-reproducing module 104 and a display module 106.

In an embodiment, the processing module 102 and the sound-reproducing module 104 are all disposed in a head-mounted device 10. The processing module 102 is electrically coupled to the sound-reproducing module 104 and the display module 106.

In an embodiment, the user is able to put the head-mounted device 10 on the head thereof to perceive the virtual reality environment presented by the head-mounted device 10. In an embodiment, the processing module 102 generates an image data 101 such that the display module 106 displays an image 103 accordingly. In an embodiment, the processing module 102 further generates an audio data 105 such that the sound-reproducing module 104 generates a sound signal 107 according to the audio data 105.

As a result, the user views the image 103 and listens to the sound signal 107 to experience the virtual reality environment presented by the head-mounted device 10.

The head-mounted device 10 enhances the performance of the virtual reality environment by using the sensor module 100. The operation mechanism of the sensor module 100 together with the other modules is described in detail below.

In an embodiment, the sensor module 100 includes two sensors 100A and 100B located at the head of the user, in which in an embodiment, the sensors 100A and 100B are disposed in the head-mounted device 10.

The sensor module 100 is configured to generate positioning information 109 by receiving laser-positioning signals 111 from a signal source 110. In an embodiment, the signal source 110 is implemented by a lighthouse of VIVE.

The processing module 102 is electrically coupled to the sensor module 100 to receive the positioning information 109 therefrom. Moreover, the processing module 102 is configured to calculate a head circumference of the user according to the positioning information 109.

In an embodiment, the sensors 100A and 100B of the sensor module 100 is located at such as, but not limited to the temple of the head of the user. The positioning information 109 includes the information of the positions of both of the sensors 100A and 100B. As a result, the processing module 102 calculates a sensor distance between the sensors 100A and 100B according to the positioning information 109 and further calculates the head circumference of the user according to the distance between the sensors 100A and 100B. In an embodiment, the positioning information 109 about the sensors 100A and 100B is determined by the time of flight (ToF) of the laser-positioning signals 111.

The processing module 102 further adjusts at least one spatial parameter of the audio data 105 according to the head circumference of the user. The sound-reproducing module 104 is configured to reproduce the sound signal 107 according to the adjusted audio data 105.

In an embodiment, the spatial parameter includes a time difference, a phase difference or a combination thereof between a first channel sound and a second channel sound of the sound signal 107, in which the first channel sound and the second channel sound of the sound signal 107 may be perceived by different ears of the user.

The processing module 102 may adjust the spatial parameter based on such as, but not limited to a head related transfer function (HRTF) according to the head circumference. The head related transfer function is a response that characterizes how an ear receives a sound from a point in space. Therefore, after the processing module 102 adjusts the spatial parameter based on the head related transfer function, the sound field produced by the sound signal 107 becomes more suitable for the physical condition of the user's ears.

As a result, the sound-reproducing system 1 in the present invention can accomplish a better sound-reproducing result by adjusting the audio data 105 according to the user's head circumference such that sound signal 107 is generated specifically according to the user's physical condition.

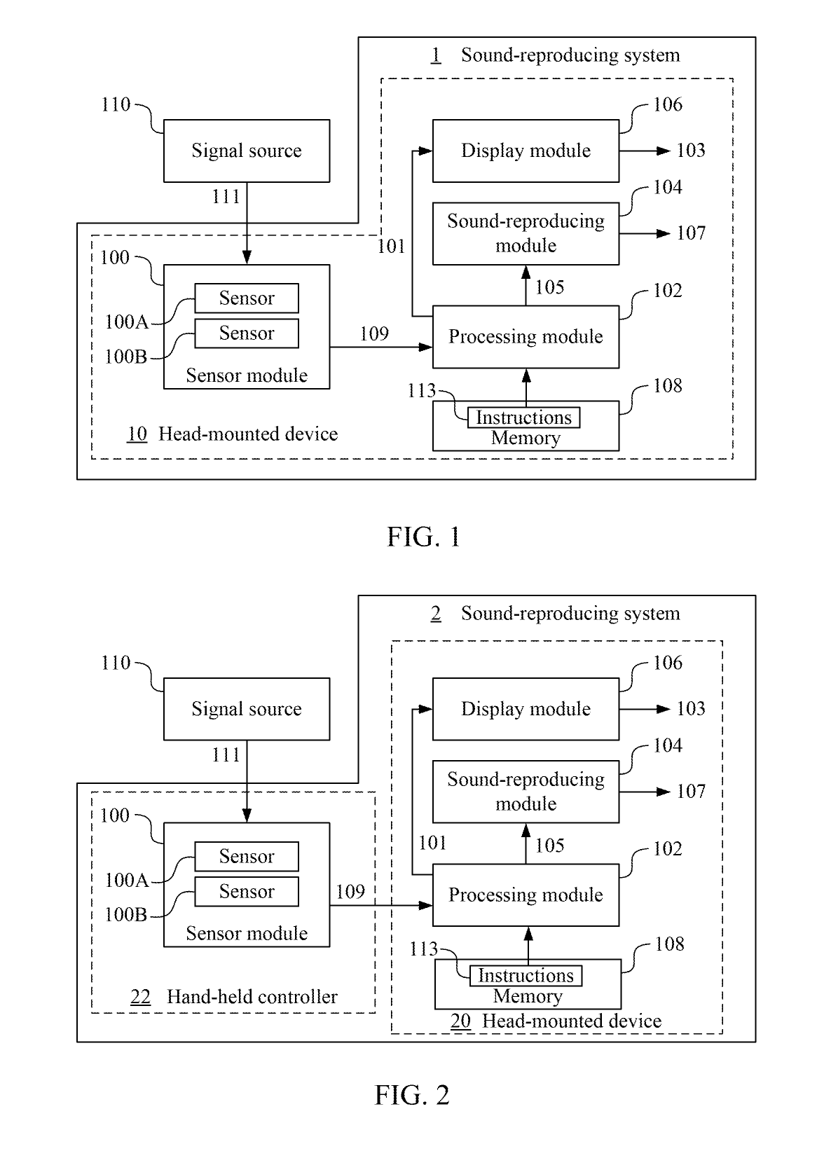

Reference is now made to FIG. 2. FIG. 2 is a block diagram of a sound-reproducing system 2 used in a virtual reality environment in another embodiment of the present disclosure.

Identical to the sound-reproducing system 1 illustrated in FIG. 1, the sound-reproducing system 2 includes the sensor module 100, the processing module 102, the sound-reproducing module 104 and the display module 106.

In the present embodiment, the processing module 102, the sound-reproducing module 104 and the display module 106 are disposed in a head-mounted device 20, and the sensor module 100 is disposed in a hand-held controller 22.

The hand-held controller 22 may include such as, but not limited two control units (not illustrated) such that each of the sensors 100A and 100B of the sensor module 100 is disposed in one of the control units. The user can hold the control units on both hands thereof. The user may use the control units to touch the head of the user such that the sensors 100A and 100B are located at the head of the user to receive the laser-positioning signals 111 from the signal source 110.

The processing module 102 receives the positioning information 109 wirelessly from the sensors 100A and 100B to calculate the head circumference of the user and adjust the spatial parameter of the audio data 105 according to the head circumference of the user. Further, the sound-reproducing module 104 reproduces the sound signal 107 according to the adjusted audio data 105.

It is appreciated that the number of the sensors in the sensor module 100 described above is merely an example. In other embodiments, the number of the sensors can be different.

For example, in an embodiment, the user may use only one control unit having one sensor to touch the head two times each corresponding to a side of the head to receive the laser-positioning signals 111 respectively. In another embodiment, the number of the sensors can be more than two such that more of the sensors in the sensor module 100 receive the laser-positioning signals 111 to provide more positioning information to accomplish a more accurate head circumference calculation result.

In an embodiment, the processing module 102 combines the positioning information 109 and other information to calculate the head circumference of the user.

For example, the processing module 102 measures an eye distance between eyes of the user according to a focal setting of the display module 106 and calculates the head circumference of the user according to both the positioning information 109 and the eye distance.

In another example, the processing module 102 receives an input head circumference information of the user from an input module (not illustrated) operated by the user and calculates the head circumference of the user according to both the positioning information 109 and the input head circumference information.

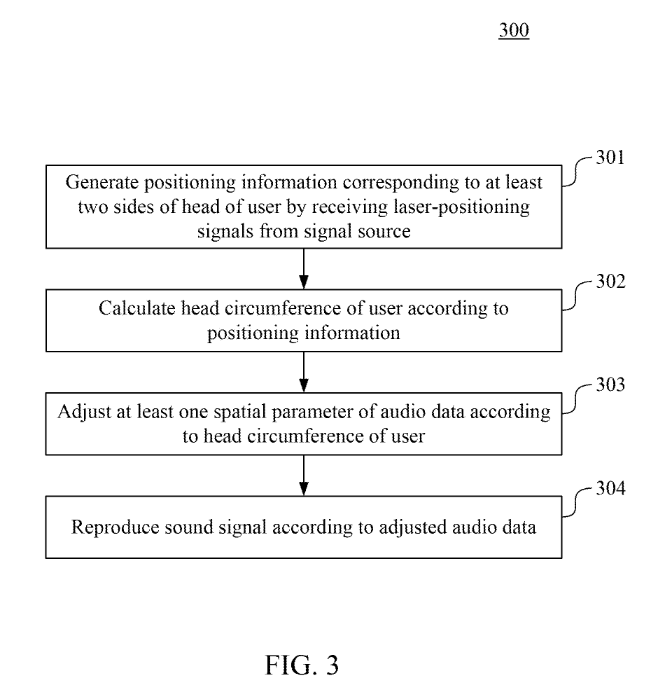

FIG. 3 is a sound-reproducing method 300 in an embodiment of the present invention. The sound-reproducing method 300 can be used in the sound-reproducing system 1 illustrated in FIG. 1 or the sound-reproducing system 2 illustrated in FIG. 2, or be implemented by using other hardware components such as a database, a common processor, a computer, a server, other unique hardware devices that have a specific logic circuit or an equipment having a specific function, e.g. a unique hardware integrated by a computer program and a processor or a chip.

More specifically, the sound-reproducing method 300 is implemented by using a computer program having computer readable instructions 113 illustrated in FIG. 1 and FIG. 2 to control the modules in the sound-reproducing system 1 or the sound-reproducing system 2. The instructions 113 can be stored in a memory 108 illustrated in FIG. 1 and FIG. 2. The memory 108 can be a non-transitory computer readable medium such as a ROM (read-only memory), a flash memory, a floppy disc, a hard disc, an optical disc, a flash disc, a tape, an database accessible from a network, or any storage medium with the same functionality that can be contemplated by persons of ordinary skill in the art to which this disclosure pertains.

The sound-reproducing method 300 includes the steps outlined below (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

In step 301, positioning information 109 corresponding to at least two sides of the head of the user is generated by receiving the laser-positioning signals 111 from the signal source 110 by the sensor module 100.

In step 302, the head circumference of the user is calculated according to the positioning information 109 by the processing module 102 disposed in the head-mounted device 10.

In step 303, at least one spatial parameter of the audio data 105 is adjusted according to the head circumference of the user by the processing module 102.

In step 304, the sound signal 107 is reproduced according to the adjusted audio data 105 by the sound-reproducing module 104 disposed in the head-mounted device 10.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A sound-reproducing method used in a virtual reality environment, comprising:
generating positioning information corresponding to at least two sides of a head of a user according to laser-positioning signals;
calculating a head circumference of the user according to the positioning information;
adjusting at least one spatial parameter of an audio data according to the head circumference of the user; and
reproducing a sound signal according to the adjusted audio data.

2. The sound-reproducing method of claim 1, wherein the spatial parameter comprises a time difference, a phase difference or a combination thereof between a first channel sound and a second channel sound of the sound signal.

3. The sound-reproducing method of claim 1, wherein the step of adjusting the spatial parameter further comprises adjusting the spatial parameter based on a head related transfer function (HRTF) according to the head circumference.

4. The sound-reproducing method of claim 1, wherein the positioning information is wirelessly transmitted between the sensor module and the processing module.

5. The sound-reproducing method of claim 1, further comprising:
calculating a sensed distance between two sides of the at least two sides of the head of the user according to the positioning information; and
calculating the head circumference of the user according to the sensed distance.

6. The sound-reproducing method of claim 1, further comprising:
measuring an eye distance between eyes of the user according to a focal setting of the display module of the head-mounted device; and
calculating the head circumference of the user according to the positioning information and the eye distance.

7. A sound-reproducing system used in a virtual reality environment, comprising:
a sensor module configured to generate positioning information corresponding to at least two sides of a head of a user by receiving laser-positioning signals from a signal source;
a processing module disposed in a head-mounted device and configured to calculate a head circumference of the user according to the positioning information and further adjust at least one spatial parameter of an audio data according to the head circumference of the user; and
a sound-reproducing module disposed in the head-mounted device and configured to reproduce a sound signal according to the adjusted audio data.

8. The sound-reproducing system of claim 7, wherein the spatial parameter comprises a time difference, a phase difference or a combination thereof between a first channel sound and a second channel sound of the sound signal.

9. The sound-reproducing system of claim 7, wherein the processing module is further configured to adjust the spatial parameter based on a head related transfer function according to the head circumference.

10. The sound-reproducing system of claim 7, wherein the sensor module is disposed on a head-mounted device.

11. The sound-reproducing system of claim 7, wherein the sensor module is disposed on a hand-held controller, and the processing module is configured to receive the positioning information wirelessly from the sensor module.

12. The sound-reproducing system of claim 7, wherein the processing module is further configured to calculate a sensed distance between two sides of the at least two sides of the head of the user according to the positioning information and calculate the head circumference of the user according to the sensed distance.

13. The sound-reproducing system of claim 7, wherein the processing module is further configured to measure an eye distance between eyes of the user according to a focal setting of the display module of the head-mounted device and calculate the head circumference of the user according to the positioning information and the eye distance.

14. A non-transitory computer readable storage medium that stores a computer program comprising a plurality of computer readable instructions to perform a sound-reproducing method used in a sound-reproducing system that is used in a virtual reality environment, the sound-reproducing system at least comprises a processing module configured to access a memory that stores the instructions and execute the instructions to perform the sound-reproducing method, the sound-reproducing method comprises:
generating positioning information corresponding to at least two sides of a head of a user according to laser-positioning signals;
calculating a head circumference of the user according to the positioning information;
adjusting at least one spatial parameter of an audio data according to the head circumference of the user; and
reproducing a sound signal according to the adjusted audio data.

15. The non-transitory computer readable storage medium of claim 14, wherein the spatial parameter comprises a time difference, a phase difference or a combination thereof between a first channel sound and a second channel sound of the sound signal.

16. The non-transitory computer readable storage medium of claim 14, wherein the step of adjusting the spatial parameter further comprises adjusting the spatial parameter based on a head related transfer function (HRTF) according to the head circumference.

17. The non-transitory computer readable storage medium of claim 14, wherein the positioning information is wirelessly transmitted between the sensor module and the processing module.

18. The non-transitory computer readable storage medium of claim 14, wherein the sound-reproducing method further comprises:
calculating a sensed distance between two sides of the at least two sides of the head of the user according to the positioning information; and
calculating the head circumference of the user according to the sensed distance.

19. The non-transitory computer readable storage medium of claim 14, wherein the sound-reproducing method further comprises:
measuring an eye distance between eyes of the user according to a focal setting of the display module of the head-mounted device; and
calculating the head circumference of the user according to the positioning information and the eye distance.
